(19) United States
(12) Patent Application Publication
(10) Pub. No.: US 2005/0009652 A1
(43) Pub. Date: Jan. 13, 2005

(54) Spiral elastic protector

(76) Inventors: Ming-Hung Chen, Taichung Hsien (TW); Jin-Long Lee, Taichung Hsien (TW)

Correspondence Address: HERSHKOVITZ & ASSOCIATES, 1725 I STREET NW, SUITE 300, WASHINGTON, DC, 20006, US

(21) Appl. No.: 10/866,814

(22) Filed: Jun. 15, 2004

(30) Foreign Application Priority Data
Jul. 7, 2003 (TW) 092212469

(51) Int. Cl. F16H 9/02; B62J 13/00; F16H 57/02

(52) U.S. Cl. 474/144; 474/147

(57) ABSTRACT

A spiral protector has a spiral wrap. The spiral wrap is made of an elastic and soft material and has multiple ring segments, an inner surface and an outer surface. The multiple rings are arranged integrally and continuously to make the wrap to form as a hose. When attaching the spiral protector onto a part of a bicycle frame, the spiral wrap is wrapped to the part of the bicycle frame to make the multiple ring segments be arranged continuously around the part of the bicycle frame.

### BACKGROUND OF THE INVENTION

1. Field of the Invention

The present invention relates to a protector, and more particularly to a spiral protector for being mounted around and protecting a part of a bicycle frame.

2. Description of Related Art

People ride bicycles for health and entertainment. A bicycle has a bicycle frame, a front wheel, a rear wheel and a transmission device. The bicycle frame is made of metal or carbon fiber and has two sides, two front stands and two back stands. The front wheel is rotatably mounted between the front stands and the rear wheel is rotatably mounted between the back stands. The transmission device is adapted to drive the rear wheel to rotate, is mounted on one of the sides of the bicycle frame close to the rear wheel and has a chain.

To make the appearance of the bicycle frame attractive, parts of the bicycle are always applied with adhesive papers with figures and characters or is painted.

When a user rides a bicycle, the rotating front and rear wheels splash gravel on the ground to the surfaces parts of the bicycle frame to make adhesive paper or painted parts worn and dirty. Especially, when the bicycle is ridden on a rugged ground, the rotating chain of the transmission device splashes greasiness onto and rubs against the rear stands to make the rear stands worn and dirty. To solve the problem, protectors, such as pieces of foam rubber are attached onto the bicycle frame to prevent the stands from wearing and dirtying. However, the shapes of the front and the rear stands are irregular, and to attach the convention protectors onto the bicycle frame is difficult.

To overcome the shortcomings, the present invention provides a spiral protector to mitigate or obviate the aforementioned problems.

### SUMMARY OF THE INVENTION

The main objective of the invention is to provide a spiral protector that can be attached onto a surface of a part of a bicycle frame conveniently and easily to prevent the surface of the bicycle frame from wearing and dirty.

The spiral protector comprises a spiral wrap. The spiral wrap is formed integrally, is made of elastic and soft material and has multiple ring segments. The multiple ring segments are arranged continuously to form a hose.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a spiral protector in accordance with the present invention;

FIG. 2 is an operational perspective view of a bicycle frame with the spiral protector in FIG. 1 showing that the spiral wrap is mounted onto a rectangular rear stand of the bicycle frame;

FIG. 3 is a perspective view of a bicycle frame with the spiral protector in FIG. 1 showing that the spiral wrap is mounted onto the rectangular rear stand of the bicycle frame in FIG. 2;

FIG. 4 is a side view in partial cross section of the rear stand with the spiral protector in FIG. 3 showing that the hose form with the multiple ring segments covers on the rectangular rear stand; and

FIG. 5 is an operational perspective view of a bicycle frame with the spiral protector in FIG. 1 showing that the spiral wrap is mounted onto a cylindrical rear stand of the bicycle frame.

### DETAILED DESCRIPTION OF PREFERRED EMBODIMENT

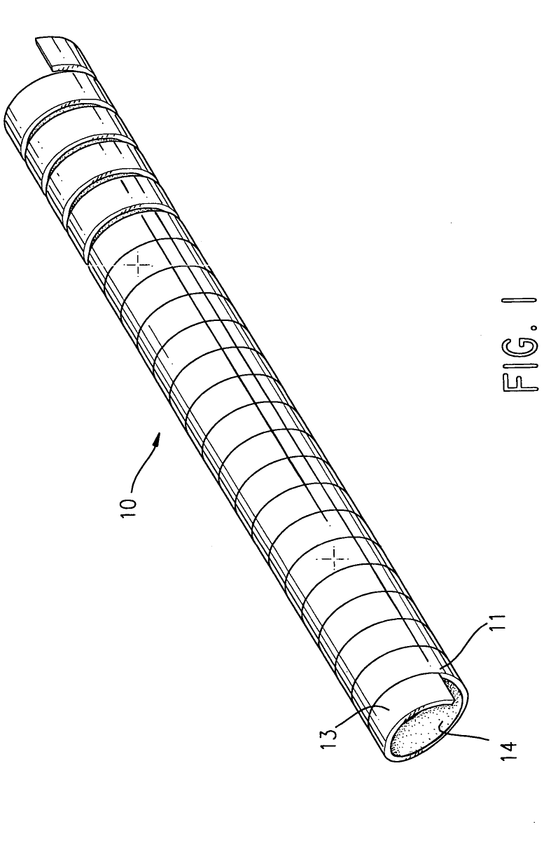

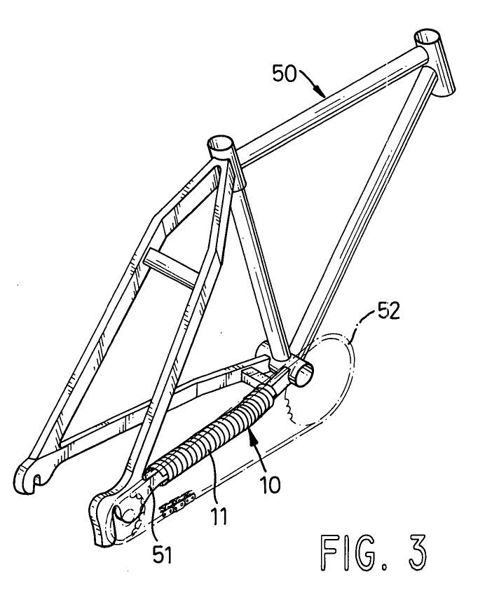

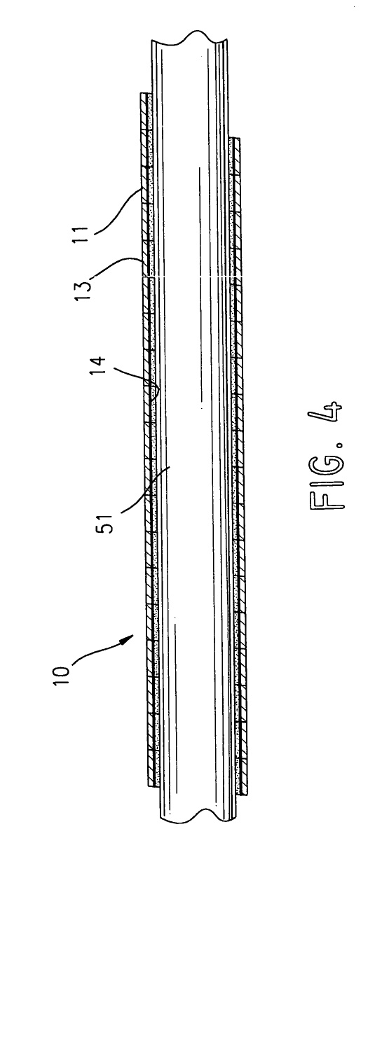

With reference to FIGS. 1, 2, 3 and 4, a bicycle frame (50) has two sides, two rectangular rear stands (51) and a transmission device (52). The transmission device (52) is mounted on one side of the bicycle frame (50) and has a chain close to one of the rear stands (51). A spiral protector in accordance with the present invention is attached to a part of the bicycle frame (50), such as the rectangular rear stands (51).

The spiral protector in accordance with the present invention comprises a spiral wrap (10). The spiral wrap (10) is made of an elastic and soft material, such as plastic or rubber and has a thickness, a width, multiple ring segments (11), an inner surface (14) and an outer surface (13). In a preferred embodiment, the thickness of the spiral wrap (10) may be sized from 0.1 millimeter (mm) to 5 mm, and the width of the spiral wrap (10) may be sized from 2 mm to 30 mm to fit with different parts of the bicycle frame (50).

The multiple ring segments (11) are arranged continuously to form the spiral wrap (10) as a hose that has a diameter. The diameter of the hose formed with the multiple ring segments (11) may be sized from 5 mm to 30 mm to fit with different parts of the bicycle frame (50).

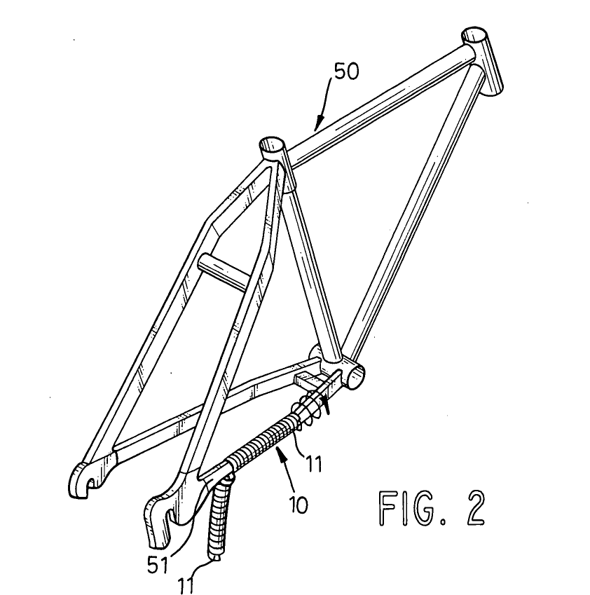

With reference FIGS. 2, 3, 4, when attaching the spiral protector to the rectangular rear stand (51), the spiral wrap (10) is wrapped to the rectangular rear stand (51) tightly to make the multiple ring segments (11) be arranged continuously around the rectangular rear stand (51). Then the hose with the multiple ring segments (11) covers the rectangular rear stand (51) completely with the inner surface (14) contacting with the surface of the rectangular rear stand (51).

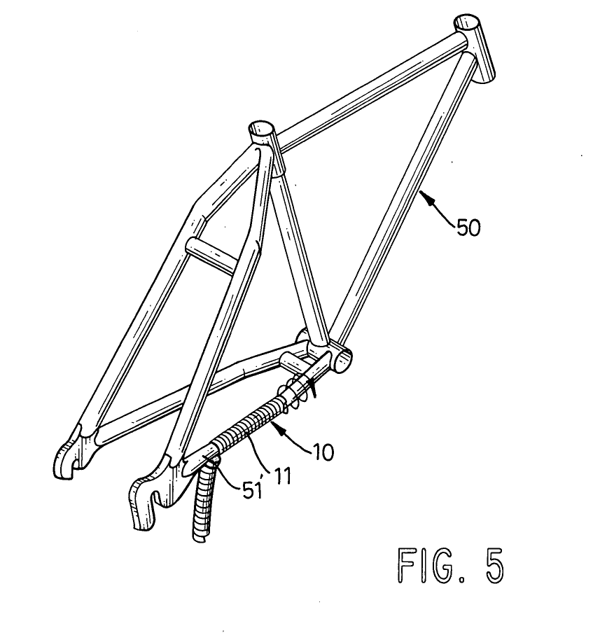

With further reference to FIG. 5, because the spiral wrap (10) is soft and may be deformed slightly, the spiral protector may also be applied easily to a rear stand with a different shape such as a cylindrical back stand (51′).

In an optional embodiment, the inner surface (14) may be a rough surface to prevent the hose from slipping along the rear stand (51,51′).

In an alternative embodiment of the invention, the outer surface (14) may be a smooth surface, such that the outer surface (14) is not easily dirtied and is conveniently cleaned.

In such an arrangement, the spiral protector may be applied easily onto parts of a bicycle frame with variable shapes, especially to the rear stand (51, 51′) that is often worn by the chain. The parts of the bicycle frame (50) can be kept from wearing and dirty. In addition, the spiral protector in accordance with the present invention has a simple structure and is easy to manufacture, so the cost for manufacturing the spiral protector is low.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A spiral protector for being attached to a rear stand of a bicycle frame comprising a spiral wrap made of an elastic and soft material and having
a thickness;
a width;
multiple ring segments arranged integrally and continuously to make the wrap to form as a hose with a diameter;
an inner surface; and
an outer surface.

2. The spiral protector as claimed in claim 1, wherein
the inner surface is a rough surface; and
the outer surface is a smooth surface.

3. The spiral protector as claimed in claim 1, wherein the thickness of the spiral wrap is sized from 0.1 millimeter (mm) to 5 mm.

4. The spiral protector as claimed in claim 2, wherein the thickness of the spiral wrap is sized from 0.1 millimeter (mm) to 5 mm.

5. The spiral protector as claimed in claim 1, wherein the width of the spiral wrap is sized from 2 millimeter (mm) to 30 mm.

6. The spiral protector as claimed in claim 2, wherein the width of the spiral wrap is sized from 2 mm to 30 mm to fit with different parts of the bicycle frame.

7. The spiral protector as claimed in claim 3, wherein the width of the spiral wrap is sized from 2 mm to 30 mm to fit with different parts of the bicycle frame.

8. The spiral protector as claimed in claim 4, wherein the width of the spiral wrap is sized from 2 mm to 30 mm to fit with different parts of a bicycle frame.

9. The spiral protector as claimed in claim 1, wherein the diameter of the hose formed with the multiple ring segments is sized from 5 millimeter (mm) to 30 mm to fit with different parts of the bicycle frame.

10. The spiral protector as claimed in claim 2, wherein the diameter of the hose formed with the multiple ring segments is sized from 5 mm to 30 mm to fit with different parts of the bicycle frame.

11. The spiral protector as claimed in claim 3, wherein the diameter of the hose formed with the multiple ring segments is sized from 5 mm to 30 mm to fit with different parts of the bicycle frame.

12. The spiral protector as claimed in claim 4, wherein the diameter of the hose formed with the multiple ring segments is sized from 5 mm to 30 mm to fit with different parts of the bicycle frame.

13. The spiral protector as claimed in claim 5, wherein the diameter of the hose formed with the multiple ring segments is sized from 5 mm to 30 mm to fit with different parts of the bicycle frame.

14. The spiral protector as claimed in claim 6, wherein the diameter of the hose formed with the multiple ring segments is sized from 5 mm to 30 mm to fit with different parts of the bicycle frame.

15. The spiral protector as claimed in claim 7, wherein the diameter of the hose formed with the multiple ring segments is sized from 5 mm to 30 mm to fit with different parts of the bicycle frame.

16. The spiral protector as claimed in claim 8, wherein the diameter of the hose formed with the multiple ring segments is sized from 5 mm to 30 mm to fit with different parts of the bicycle frame.
